(19) United States
(12) Patent Application Publication
(10) Pub. No.: US 2018/0194034 A1
(43) Pub. Date: Jul. 12, 2018

(54) DEVICE AND METHOD FOR WETTING PARTICLES

(71) Applicant: BRAV-O-TECH GMBH, Duisburg (DE)

(72) Inventors: Udo GEHRER, Würselen (DE); Roland HICKER, Bochum (DE); Johannes HICKER, Duisburg (DE)

(73) Assignee: BRAV-O-TECH GMBH, Duisburg (DE)

(21) Appl. No.: 15/741,869

(22) PCT Filed: Jun. 10, 2016
(86) PCT No.: PCT/EP2016/063348

§ 371 Date: Jan. 4, 2018

(30) Foreign Application Priority Data
Jul. 8, 2015 (DE) 102015212798.2

(51) Int. Cl. B27N 1/02; B01F 9/02; B01F 3/12; B01F 5/26; B01F 5/20; B01F 5/22; B01F 9/06

(52) U.S. Cl. CPC B27N 1/0218; B01F 9/025; B01F 3/1228; B01F 5/26; B01F 5/205; B01F 2215/0495; B01F 9/06; B01F 2215/0422; B01F 2215/0468; B01F 2215/0481; B01F 5/225

(57) ABSTRACT

A device for wetting particles, in particular wood particles, with an application agent, at least one conduit transporting a fluid as a fluid stream and an end section which forms an outlet. The fluid can be introduced in the direction of the main flow into a container containing the particles, via the outlet. The particles are in the container in a loosened state and/or can be loosened. The application agent, for spraying by a nozzle device with a speed component directed against the main flow direction, can be introduced into the fluid stream and can be guided to the particles by the fluid stream.

The present invention relates to a device for wetting particles, in particular wood particles such as e.g. wood fibers, said device comprising a conduit transporting a fluid as a fluid stream and having an end section which forms an outlet, wherein, via the outlet, the fluid can be introduced in a main flow direction into a container containing the particles, wherein the particles in the container are in a loosened state and/or in a state adapted to be loosened. The invention further relates to a corresponding method.

In the production of plates made of fibers, MDF, HDF, wood material or plastic, devices are known wherein particles will be conveyed in a particle flow, wherein the particle flow is formed from a mixture of particles with steam and a binding agent will be supplied to the particles. DE 10 2008 063 914 A1 discloses such a device wherein the binding agent is supplied to the particle flow in the conduit transporting the particle flow. It is further known that a conduit transporting the particle flow can be designed as a so-called blowline which has inserted into it a dryer for drying the particles. DE 10 2006 026 124 A1 and WO 2009/116877 A1 disclose designs of this type, wherein the binding agent is supplied directly at the outlet of the blowline. In such a design, the outlet of the blowline forms a kind of mixing nozzle where the particles will be mixed with the binding agent supplied to the nozzle. DE 4122842 A1 discloses a device wherein the binding agent will be sprayed via a nozzle onto the particle flow exiting from an outlet of the blowline.

In all of the above mentioned devices, the binding agent will be supplied directly to a particle flow of particles and steam in the main flow direction of this particle flow. In such arrangements, it is difficult to achieve an advantageous distribution of the binding agent across the particles.

Generally, the supplying of binding agents or application agents into a particle flow which is normally formed as a mixture of particles with steam can lead to difficulties because the application agent may happen to react with the steam. Supply of a binding agent into a conduit transporting the particle flow may cause adherence to the tube conduit walls, with the resultant risk of clogging of the tube conduits.

Thus, it is an object of the present invention to provide a device for wetting particles which makes it possible, while avoiding the problems known from the state of the art, to achieve an improved wetting of the particles. It is a further object of the present invention to provide a corresponding method.

The invention is thus defined by the features of claims 1 and 10.

In the device according to the invention, provided for wetting particles, in particular wood particles, with an application agent, said device comprising at least one conduit transporting a fluid as a fluid stream and having an end section which forms an outlet, wherein, via said outlet, the fluid can be introduced in a main flow direction into a container containing the particles, wherein the particles in the container are in a loosened state and/or in a state adapted to be loosened, it is provided that the application agent, for being sprayed, can be introduced into the fluid stream by means of a nozzle device with a speed component directed against the main flow direction and can be applied to the particles by means of the fluid stream.

In other words: The invention provides that the application agent will be atomized by means of the fluid stream and that the fluid stream with the atomized application agent will be supplied to the loosened particles. In the process, the application agent is introduced via the nozzle device into the fluid stream in such a manner that the application agent has a speed component directed against the main flow direction. Thus, the nozzle device is directed against the main flow direction and extends e.g. at an obtuse angle to the main flow direction. It has become evident that such a supply of the application agent is of particular advantage for the distribution of the application agent in the fluid stream since the fluid stream will impinge on the application agent when exiting the conduit transporting the fluid stream. Particularly, the application agent can be supplied in a non-atomized state. This will result in a collision of the fluid stream with the introduced application agent so that the application agent will be atomized in a fan-like manner. By introducing the application agent with a speed component directed against the main flow direction, it is effected that, when the application agent is entrained during atomization, the application agent will follow a curved course, while at the same time being formed. Achieved thereby is a particularly advantageous distribution of the application agent in the fluid stream, resulting in a particularly advantageous wetting of the loosened particles.

The fluid can be e.g. air. The application agent can be e.g. a binding agent.

Preferably, it is provided that the container is formed by a drum, wherein the particles can be circulated within the drum. Thereby, it can be accomplished in an advantageous manner that the particles will be loosened. The drum can be designed e.g. in the form of a drum mixer or a rotatable mixing container.

Preferably, the container has a considerably larger diameter than the conduit transporting the fluid stream, e.g. a diameter at least three times as large. The end section of the conduit transporting the fluid stream can e.g. be hung into the container. For this purpose, an outlet device can be formed which takes up the end section of the transporting conduit. The outlet device can be articulated within the container, thus making it possible to adjust the orientation of the fluid stream issued from the outlet. The joint of the articulation can allow for a pivoting of the outlet device e.g. in two directions.

In this arrangement, it can be provided that the outlet device is connected to a fluid supply via a flexible conduit. The flexible conduit can be connected e.g. to a compressor.

The nozzle device can be fastened e.g. to the outlet device. A feed conduit of the nozzle device can be connected, e.g. via a flexible feed conduit, to a tank for the application agent.

The drum can be rotatable, and/or a circulation of the particles can be performed pneumatically. For this purpose, a blowing device can be provided which is operative to blow air into the drum at one or a plurality of sites so as to whirl up the particles.

It can also be provided that the container is formed by a flow tube, wherein the particles are transportable through the flow tube by means of a particle flow. In this case, the particle flow can be twisted to ensure that the particles in the particle flow will be loosened.

Thus, the device of the invention is applicable in a particularly flexible manner since the application agent can be fed, by means of the fluid stream, into a particle flow at any desired site.

Preferably, it is provided that the nozzle device comprises at least one jet-forming nozzle. In other words: The nozzle of the nozzle device is not an atomizing nozzle but will form an application agent jet. This has the advantage that, when the fluid stream impinges onto the application agent, the latter will first be atomized, wherein, under the effect of the impinging fluid stream, outer regions arranged on the side of the application agent facing toward the fluid stream will be reduced. In this manner, it is accomplished that said application agent jet can penetrate very far into the fluid stream, thereby allowing for an advantageous atomization of the application agent into the fluid stream. Further, the jet-forming nozzle is of a simple design, thus obviating the need for complicated nozzle geometries as are provided in the state of the art. Also, when using a jet-forming nozzle, the danger of occlusion of the nozzle due to adhering application agent is relatively low, resulting in lesser expenditure for maintenance. Further still, as compared to atomizing nozzles, jet-forming nozzles are energetically more favorable.

In the above arrangement, it can be provided that the nozzle device comprises two or more jet-forming nozzles which are arranged parallel to each other. This makes it possible to generate three liquid jets of binding agents that are distributed across the width of the fluid stream.

Preferably, it is provided that the nozzle direction of the at least one nozzle of the nozzle device is arranged at an angle β relative to the main flow direction, wherein: 90°<β<180°. The angle β can be e.g. in the range from 120° to 150° and preferably is 150°.

It can also be provided that the at least one jet-forming nozzle of the nozzle device has an elongated cross section, e.g. an elliptic cross section. This makes it possible to form an application agent jet having a corresponding cross section. In this arrangement, the orientation of such a nozzle can extend transversely to the main flow direction so that the application agent jet has a wider dimension which runs transversely to the main flow direction, or it can extend along with the main flow direction so that the wider side of the application agent jet runs in the main flow direction. Said transverse orientation of the nozzle relative to the main flow direction can be of advantage since the application agent jet will then have a relatively wide extension transversely to the nozzle direction, thus making it possible to achieve, in the fluid stream, an advantageous distribution in a direction transversely to the nozzle direction. Said orientation of the nozzle along the wider extension in the main flow direction has the advantage that the engagement surface on the application agent jet, which surface is formed between the fluid stream and the application agent jet, is relatively small in comparison to the thickness of the application agent jet so that, for a long stretch of way in the fluid stream, at least a part of the application agent jet will remain in the form of a jet before a complete atomization of the application agent has occurred. Thereby, the application agent jet can penetrate into the fluid stream very deeply, thus providing for an advantageous distribution of the application agent in the fluid stream.

According to a particularly preferred embodiment of the invention, it is provided that the nozzle device, when viewed in the main flow direction, is arranged behind the outlet. In other words: The application agent is introduced into the fluid stream in a direction opposite to the main flow direction when the fluid stream has left the conduit via the outlet. If, for instance, the fluid stream is accelerated when leaving the conduit via the outlet, it will have the highest speed in a region directly behind the outlet so that the fluid stream can have very high speed, whereby the application agent, when impinging onto the fluid stream, can be atomized in a particularly advantageous manner.

According to a preferred embodiment, it is provided that the at least one nozzle of the nozzle device is oriented onto the line of intersection of the central plane of the fluid stream with the outlet plane of the outlet of the conduit, or is oriented above this line of intersection. Thereby, it is achieved that the introduced application agent will impinge substantially into the section of the fluid stream where the speed of the particle flow is highest. Thereby, a particularly advantageous distribution of the binding agent is achieved.

According to a preferred embodiment of the invention, it is provided that each nozzle comprises a nozzle feed conduit, said nozzle feed conduit having a diameter D and, before the nozzle exit, a straight-lined feed section having a length L, wherein L:D>1.5. Thereby, it is accomplished that application agent fed to the nozzle, while being fed e.g. through a massively deflected feed conduit, will calm down toward the nozzle exit, so that a jet can be formed in an advantageous manner.

According to a preferred embodiment of the invention, it is provided that the end section of the conduit comprises a flow device for accelerating the fluid stream. Thereby, it is ensured that the fluid stream will have a very high speed, thus effecting an advantageous atomization of the application agent.

The flow device can be formed with a tapering of the cross section of the end section toward the outlet. This makes it possible to accelerate the fluid stream in a technically simple manner. The end section can e.g. be nozzle-shaped. In this case, the cross section can be a trapezoidal shape. In other words: The cross section of the end section is tapering in the upward direction. Thereby, it is achieved that, in the lower region of the fluid stream flowing from the outlet, there is a larger mass flow of fluid which acts as a kind of support flow for the overlying stream portion of the fluid flow which contains atomized application agent. In this manner, the fluid stream carrying the atomized application agent can be guided very far into the container while no excessive quantity of application agent will fall out from the fluid stream under the influence of gravity.

According to a preferred embodiment of the invention, it is provided that an annular space surrounds the end section of the conduit, which annular space is connected to the conduit and opens into the container. Such an annular space will generate an annular flow which, when entering the container, will surround the fluid stream comprising the atomized application agent. The annular flow formed in this manner will lay itself like an “envelope” around the fluid stream and will effect a kind of evacuation of the fluid stream. Thereby, it can be safeguarded that the fluid stream with the atomized application agent can flow within the container along a relatively long distance, while the fluid stream with the atomized application agent will not be exposed to larger external influences. Further, the expansion behavior of the fluid stream can be influenced. Thus, it can be safeguarded that the atomized application agent can be supplied to the particles to a high extent.

The invention further relates to a method for wetting particles, in particular wood particles, with an application agent, wherein a fluid is fed in the form of a fluid stream in a main flow direction into a container containing the particles, wherein the particles in the container are in a loosened state and/or will be loosened. The method of the invention is characterized in that the application agent, for being sprayed, is introduced into the fluid stream with a speed component directed against the main flow direction and the atomized application is supplied to the particles by means of the fluid stream.

Thus, in a manner comparable to the device of the invention, the method of the invention makes it possible that the application agent is in an advantageous manner atomized and fed to the particles.

Preferably, it is provided that the application agent is introduced into the fluid stream in the form of at least one liquid jet. Feeding the application agent in this manner has proven to be particularly advantageous since the application agent will be atomized in a fan-like manner in the fluid stream, resulting in an advantageous distribution of atomized application agent in the fluid stream.

It can be provided that the application agent will be introduced with a pressure in the range from 3 to 40 bar. In the framework of the invention, the pressure by which the application agent is introduced is understood to be the pressure prevailing immediately before the nozzle. It has become evident that the introducing of the application agent with such a pressure makes it possible to generate a particularly advantageous liquid jet which will lead to a particularly advantageous distribution of the application agent into the fluid stream.

It can be provided that the application agent is introduced at a speed of at least 10 m/sec with a viscosity of the application agent in the range from 30 to 150 mPa·s. With such a high speed of the application agent, it is safeguarded that the application agent can penetrate relatively deeply into the fluid stream and there will thus be obtained a particularly advantageous atomization and distribution of the application agent. Further, with such a high speed, the speed component directed against to the main flow direction will be relatively high, thus rendering it possible that the application agent can hit the fluid stream at a very high relative speed so that a high kinetic energy will be available for atomizing the application agent.

The method of the invention can be performed in a particularly advantageous manner by use of the device of the invention.

Preferably, it is provided that the fluid stream is accelerated prior to entering into the container. In this manner, also the fluid stream will have a high kinetic energy so that, when the application agent is impinging, a particularly advantageous atomization of the application agent can be reached.

The fluid stream can have a speed of at least 100 m/sec when entering into the container. Preferably, the fluid stream has a speed of 190 m/sec.

According to a preferred embodiment of the method, it is provided that an annular flow surrounding the fluid stream is generated that is introduced into the container. With the aid of such an annular flow, the expansion behavior of the fluid stream can be influenced, thus allowing to feed the fluid stream to the loosened particles in an advantageous manner.

In the method of the invention, it can be particularly provided that the application agent is fed to the fluid stream immediately after leaving the conduit through the outlet. In this situation, the liquid jet of the application agent can be directed at the outlet of a conduit conducting the fluid stream. The liquid jet of the application agent can be arranged at an angle β relative to the main flow direction of the fluid stream, wherein the angle β is preferably in the range from 90° to 180° and more preferably in the range from 120° to 150° and most preferably is 150°.

The invention will be explained in greater detail hereunder with reference to the Figures briefly outlined below.

The following is shown:

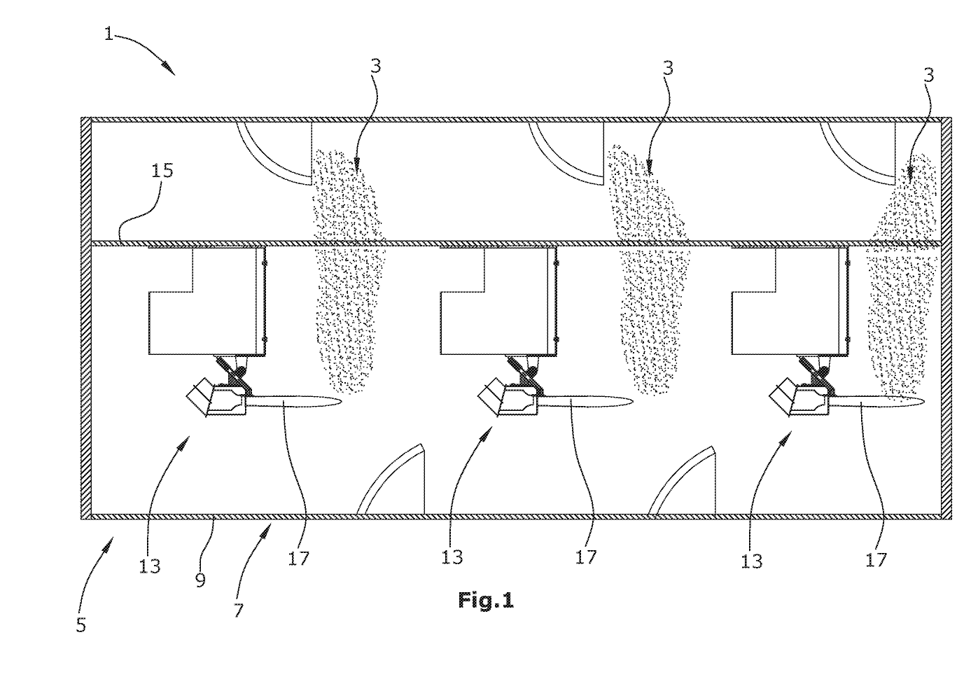

FIG. 1 is a schematic sectional view of the device 1 according to the invention,

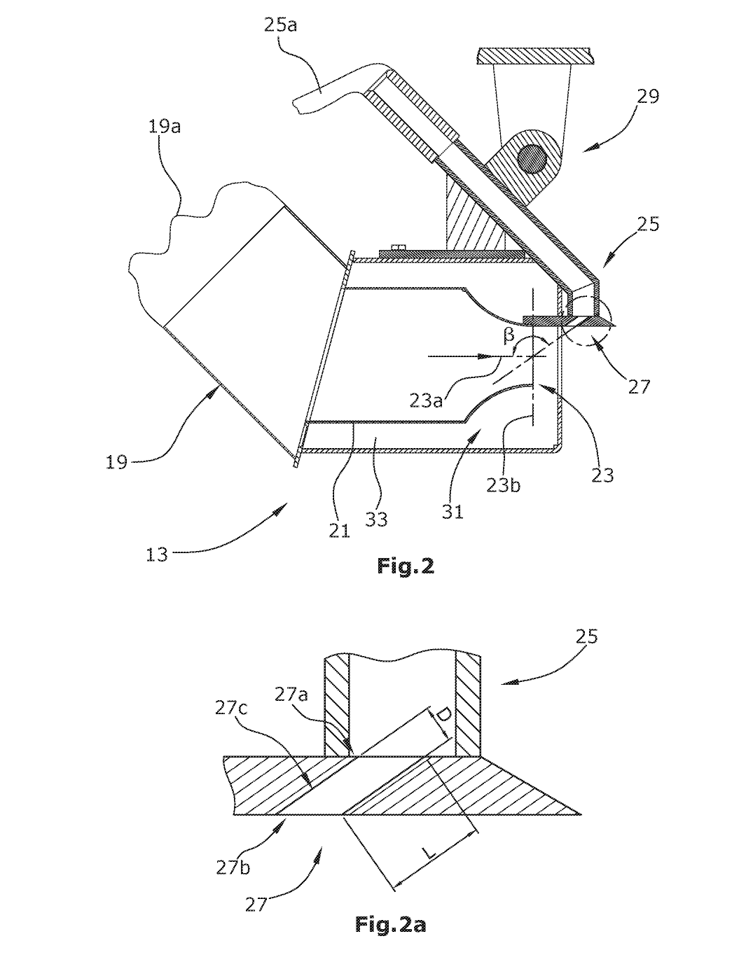

FIG. 2 is a schematic detailed view of the outlet device,

FIG. 2a is a schematic detailed view of the nozzle in FIG. 2, and

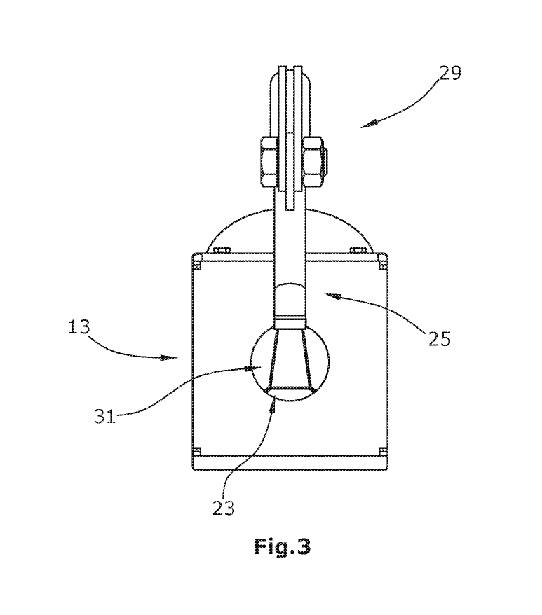

FIG. 3 is a schematic plan view onto the outlet of the outlet device in FIG. 2.

In FIG. 1, a device 1 according to the invention, provided for wetting particles 3, is schematically shown in sectional view. Device 1 comprises a container 5 which is designed as a drum 7. Within container 5, the particles 3 can be loosened. For this purpose, said drum 7 comprises a rotatable enclosure 9 with circulating fixtures 11 arranged internally of it. Upon rotation of enclosure 9, the particles will be entrained and will fall down under the effect of gravity, thereby being loosened.

Container 5 comprises a feed device, not shown, and a discharge device, said devices being operative to feed the particles to drum 7 and, respectively, to discharge them from the latter. Container 5 can be arranged e.g. at an oblique orientation so as to allow for a gravity-induced transport of the particles 3 through drum 7.

In the interior of drum 7, three application devices 13 are arranged which are operative to feed an application agent, e.g. a binding agent, to the particles 3.

Said outlet devices 13 are arranged at predefined mutual distances on a mounting structure 15 within drum 7. By means of the outlet devices 13, a fluid stream 17 inclusive of application agent atomized in it will be introduced into drum 7.

In FIG. 2, an outlet device 13 is schematically shown in sectional view.

Outlet device 13 comprises a conduit 19 for transporting a fluid in the form of a fluid stream, said outlet device comprising an end section 21 forming an outlet 23. The fluid transported in the form of a fluid stream via said conduit 19 will be introduced, in a main flow direction, into container 5. In FIG. 2, the main flow direction is indicated by an arrow.

By means of a nozzle device 25, the application agent can be introduced into the fluid stream with a speed component directed against the main flow direction. Thereby, the application agent will be atomized and distributed in the fluid stream so that, by means of the fluid stream, the application agent can be fed to the particles 3.

The fluid can be e.g. air.

Nozzle device 25 comprises a jet-forming nozzle 27 which is shown in greater detail in FIG. 2a. Said nozzle 27 comprises a nozzle feed conduit 27a. The nozzle feed conduit 19a has a diameter D. Before the nozzle exit 27b, there is formed a straight-lined feed section 27c having a length L, wherein: L:D>1.5. Thereby, it is safeguarded that application agent being fed via nozzle device 25 will have sufficiently calmed down before exiting from nozzle 27 via nozzle exit 27b and that the nozzle 27 will be able to form a clear-shaped jet of application agent.

Said nozzle 27 has a nozzle direction arranged at an angle β relative to the main flow direction, wherein, in FIG. 2, the angle β is about 150°. Thereby, the application agent fed by means of nozzle device 25 is given a relatively high speed component which directed against the main flow direction. Thus, the fluid flowing through outlet 23 will hit upon the application agent, wherein this collision will accomplish a fine atomization and distribution of the application agent in the fluid stream.

In the exemplary embodiment shown in FIG. 2, the end section 21 is oriented horizontally, and the nozzle 27 of nozzle device 25 is oriented onto the line of intersection of the horizontal central plane 23a of the agent stream with the vertical outlet plane 23b of the outlet 23. This orientation can also be provided above this line of intersection. Such an arrangement has turned out to be of particular advantage for the atomization of the application agent.

Outlet device 13 is fastened to mounting structure 15 via an articulation device 29. By means of the articulation device 29, the application device 13 can be pivoted in various directions, thus allowing for an optimal orientation toward the particles 3. Conduit 19 is connected, via a schematically indicated flexible conduit 19a, to a compressor—not shown—via which the fluid can be fed at a high speed to outlet 23. Nozzle device 25 is connected, via a likewise schematically indicated flexible conduit 25a, to a tank—not shown—for the application agent.

End section 21 of conduit 19 comprises a flow device 31 serving for accelerating the fluid stream. Said flow device is designed as a nozzle, wherein the cross section of end section 21 is tapering toward outlet 23.

In FIG. 3, a plan view of outlet 23 is schematically shown. As can be seen in FIG. 3, the cross section of outlet 23 has a trapezoidal shape. Thereby, it is achieved that the mass flow of the fluid stream which leaves the outlet 23 in the lower region is relatively large, so that a support flow will be formed which will support the overlying portion of the fluid stream, thus rendering it possible that the fluid stream with the atomized application agent can be transported relatively far within drum 7.

As best visible in FIG. 2, outlet device 13 further comprises an annular space 33 surrounding the end section 21, said annular space being connected to the conduit 19 on the end facing away from outlet 23. By means of the annular space, there is generated an annular flow which, when exiting from outlet device 13, will lay itself around the fluid stream comprising the atomized application agent. With the aid of this annular flow, the expansion behavior of fluid stream with the atomized application agent can be influenced in an advantageous manner, thus allowing for the formation of a long fluid stream within drum 7 without the risk of application agent escaping from the fluid stream. Thereby, the application agent can be applied to the particles 3 in atomized form in an advantageous manner.

The application agent can be introduced at a pressure in the range from 3 to 40 bar. In the process, the application agent can have a speed of at least 10 m/sec with a viscosity of the application agent in the range from 30 to 150 mPa·s.

The fluid stream can be e.g. air. The application agent can be a binding agent or also another agent for improving the properties of the particles. The particles can be, for instance, wood particles, e.g. wood fibers.

1-15. (canceled)

16. A device for wetting particles, in particular wood particles, with an application agent, said device comprising:
at least one conduit transporting a fluid as a fluid stream and having an end section which forms an outlet, wherein, via the outlet, the fluid can be introduced in a main flow direction into a container containing the particles, wherein the particles in the container are in a loosened state and/or in a state adapted to be loosened, wherein the application agent, for being sprayed, can be introduced into the fluid stream by a nozzle device with a speed component directed against the main flow direction and can be applied to the particles by the fluid stream.

17. The device according to claim 16, wherein the container is formed by a drum, wherein the particles can be circulated within the drum.

18. The device according to claim 17, wherein the drum is rotatable and/or a circulation of the particles is performed pneumatically.

19. The device according to claim 16, wherein the nozzle device comprises at least one jet-forming nozzle.

20. The device according to claim 19, wherein the nozzle direction of the at least one nozzle of the nozzle device is arranged at an angle β relative to the main flow direction, wherein there applies: 90°<β<180°.

21. The device according to claim 16, wherein the nozzle device, when viewed in the main flow direction, is arranged behind the outlet.

22. The device according to claim 16, wherein the end section of the conduit comprises a flow device for accelerating the fluid stream.

23. The device according to claim 22, wherein the flow device comprises a tapering of the cross section of the end section toward the outlet.

24. The device according to claim 16, wherein an annular space surrounds the end section of the conduit, said annular space being connected to the conduit and opening into the container.

25. A method for wetting particles, in particular wood particles, with an application agent, comprising:
a fluid is fed in the form of a fluid stream in a main flow direction into a container containing the particles, wherein the particles in the container are in a loosened state and/or will be loosened, wherein the application agent, for being sprayed is introduced into the fluid stream with a speed component directed against the main flow direction and the atomized application agent is supplied to the particles by means of the fluid stream.

26. The method according to claim 25, wherein the application agent is introduced into the fluid stream in the form of at least one liquid jet.

27. The method according to claim 25, wherein the application agent is introduced with a pressure in the range from 3 to 40 bar.

28. The method according to claim 25, wherein the application agent is introduced at a speed of at least 10 msec with a viscosity of the application agent in the range from 30 to 150 mPa·s.

29. The method according to claim 25, wherein the fluid stream is accelerated prior to entering the container.

30. The method according to claim 25, wherein an annular flow surrounding the fluid stream is generated that is introduced into the container.
